(19) United States
(12) Patent Application Publication
(10) Pub. No.: US 2002/0032141 A1
(43) Pub. Date: Mar. 14, 2002

(54) System and method to clean and disinfect hard surfaces using electrolyzed acidic water produced from a solution of NaCl

(76) Inventor: Gene Harkins, Salt Lake City, UT (US)

Correspondence Address: Gene Harkins, Suite 500, 3760 So. Highland Drive, Salt Lake City, UT, 84106, US

(21) Appl. No.: 09/946,947

(22) Filed: Sep. 5, 2001

Related U.S. Application Data
(63) Continuation of application No. 60/231,016, filed on Sep. 8, 2000.

(51) Int. Cl. C23F 14/02; C23G 1/00; C11D 1/00

(52) U.S. Cl. 510/253; 510/256

(57) ABSTRACT

A system and method to clean and disinfect hard surfaces such as plaster, drywall, concrete, linoleum, counter tops, wood, metal, tile and the like is disclosed. The system and method use electrolyzed acidic water produced by an electrolysis process using a standard electrolyte solution of water and an electrolyte, wherein the electrolyte includes sodium chloride (NaCl) at a concentration between about 1% and 50%. In a preferred embodiment about a 20% concentration of sodium chloride is used. The electrolyzed acidic water produced by this method is effective in cleaning and disinfecting hard surfaces.

### CROSS-REFERENCE TO RELATED APPLICATIONS

This application is a continuation of provisional patent application Serial No.: 60/231,016 filed Sep. 8, 2000.

### THE FIELD OF THE INVENTION

This invention relates to cleaning generally, and more particularly to a system and method to clean and disinfect hard surfaces by using electrolyzed acidic water produced by an electrolysis process using the standard electrolyte solution of 20% sodium chloride (NaCl).

### BACKGROUND OF INVENTION

Ever since carpets came into common use, people have wrestled with the difficulty of keeping them clean. Carpet, unlike other fabric in household use, is exposed to an enormous amount of foreign matter such as dirt, grass, leaves, sand, dust, mud, animal hair, and spilled food. The problem is compounded by both the permanent (e.g. wall-to-wall) installation of carpet and the length of fibers found in many carpets. Permanent (e.g. wall-to-wall) installation requires on-site cleaning. Bundles of yarns comprised of many fibers tend to capture or adhere to soiling, such as particulate matter. Conventional washing and cleaning processes remain ineffective. “Hot-water extraction” methods have been developed to facilitate carpet cleaning. Hot water may actually include water; saturated, two-phase, steam and water; or superheated steam. The latter is not commonly relied upon, since it is typically hotter than the distortion temperature of synthetic fibers.

According to these methods, water is heated, pressurized, supplemented with chemical additives, and applied to carpet in order to dissolve or release soils and particulates and to suspend the resulting matter in the water (e.g. solvent, carrier, etc.). A “vacuum” system then extracts the dissolved soils, suspended particulates, and water out of the fibers. The water and air flows drawn by the vacuum system carry the entire mixture to a holding tank. Most carpet and upholstery cleaning devices utilize a water-based cleaning solution that contains organic detergents. The solution is directed in a forceful stream onto the material to be cleaned. The temperature of the solution, the force of the directed stream, and the chemistry of the solution are all factors in the device's ability to clean effectively.

Hospital infections due to methicillin-resistant Staphlococcus aaureus (MRSA) have greatly increased since 1980. For prevention of hospital infection, thorough cleaning of the hospital environment is important. The hospital environment includes many soft fabric surfaces such as carpets. Additionally, hard tile floors, walls, counter tops, and the like must be cleaned and disinfected to prevent the spread of hospital infections. Chemical disinfectants have been usually used for this purpose. However, the use of chemical disinfectants creates the risk of generating resistant strains. Moreover, many chemicals used can be toxic to humans.

Electrolyzed oxidizing water (EO water) and electrolyzed alkaline water are both useful for disinfecting and cleaning, and therefore can be used as an alternative to the detergent solutions for the cleaning of fabric, carpet, and hard surfaces. U.S. Pat. No. 5,815,869, to John M. Hopkins, discloses a cleaning system that utilizes a wand that both injects hot EO water at a high pressure and at a shallow angle, and simultaneously recovers the water by a strong vacuum. The EO water serves as a solvent, much of which leaves the wand in the form of microdroplets, to solublize dirt and grease from the fabric fibers. EO water is acidic with a pH of 2.3 to 2.8. Electrolyzed alkaline water has a pH of 11.2 to 11.6. Both have cleaning action, with the alkaline form superior for removing lipid based or organic stains. Both forms of electrolyzed water remove absorbed dirt and stains and have microbiocidal properties. Electrolyzed oxidizing water, which is mildly acidic, but very active, helps achieve a fresh, clean odor in the cleaning of carpets and hard surfaces.

Electrolyzed oxidizing water and electrolyzed alkaline water can be produced with commercially available equipment that electrolyzes tap water or water with an electrolyte added to improve the conductivity of the water in the electrolyzing machine. Electrolyzed oxidizing water having a pH of 2.8 or below, an oxidation reduction potential of 1100⁺ millivolts (mV) or more and electrolyzed alkaline water having a pH of 11.2 to 11.6, an oxidation reduction potential of 840 to 847⁻ mV can be produced from tap water using a commercial water generator.

### BRIEF SUMMARY OF THE INVENTION

The present invention relates to a system and method of cleaning hard and soft surfaces with electrolyzed oxidizing water produced from an electrolyte solution. According to one aspect of the invention, an electrolyte solution for producing electrolyzed water includes water and an electrolyte, wherein the electrolyte includes sodium chloride (NaCl).

In one presently preferred embodiment, an electrolyte solution is made by combining tap or other water with a concentration of about 1% to 50% sodium chloride. However, a concentration of 10% to 30% sodium chloride is more preferable. In certain embodiments a concentration of about 20% of sodium chloride is preferred. In other embodiments the NaCl may be used in a concentration of about 125 g/liter.

The electrolyte solution may be used in an electrolyzed water generator to create electrolyzed acidic water. The electrolyzed acidic water is an effective cleaning solution that can be used on soft surfaces such as carpets, fabrics, and the like and for cleaning hard surfaces such as plaster, drywall, concrete, linoleum, counter tops, wood, and the like. Moreover, the electrolyzed acidic water has been shown to have excellent microbiocidal properties on a wide range of bacteria and viruses.

### BRIEF DESCRIPTION OF THE DRAWINGS

In order that the manner in which the advantages and features of the invention are obtained, a more particular description of the invention summarized above will be rendered by reference to the appended drawings. Understanding that these drawings only provide selected embodiments of the invention and are not therefore to be considered limiting of the scope, the invention will be described and explained with additional specificity and detail through the use of the accompanying drawings in which:

FIG. 1 is a schematic diagram of a cleaning system in accordance with the present invention;

FIG. 2 is a schematic diagram of an alternate embodiment of the cleaning system of the present invention; and

FIG. 3 is a schematic diagram of a portable cleaning system in accordance with the present invention.

### DETAILED DESCRIPTION OF THE INVENTION

In one embodiment of the invention, an electrolyzing water generator is fed a combination of water and electrolyte that passes into channels containing electroplates which are either anodic (+) or cathodic (−). These plates are separated by a conductive diaphragm or special “membrane”. Sodium chloride (NaCl) may be used to form the electrolyte solution necessary for current flow. In one embodiment of the invention, sodium chloride is used at concentrations of between 1% and 50%. More preferably, the sodium chloride is used at a concentration of about 10% to 30%. A concentration of about 20% sodium chloride is preferred in certain embodiments.

Pure water cannot be electrolyzed to any useful degree. Sodium and chloride ions (Na⁺Cl⁻) derived from the dissolution of NaCl migrate to opposite electrical poles. Thus when electrical energy is supplied to the machine, Na⁺ flows in a net mass manner toward the cathode (−) and Cl⁻ to the anode (+). In general overview, water is decomposed (electrolyzed) owing to the high reactivity of Na⁺ in the reaction where: 2Na⁺+2H₂O=2NaOH=H₂. Since sodium ions are attracted to the cathode, the above reaction occurs in the cathodic channel to form a small amount of soduim hydroxide as water flows through the channel. The sodium hydroxide (NaOH) ionizes as NaOH=Na⁺+OH⁻. The water from the cathode channel is called electrolyzed alkaline water. Electrolyzed alkaline water is an excellent cleaning solution, particularly with lipid-based or organic stains.

In the anodic channel, where chloride ions (Cl⁻) accumulate, electrons from Cl⁻ are given up to the electron deficient anode and hence: 2Cl⁻−2e=Cl₂. The chloride is soluble in water and reacts with water as Cl₂+H₂O=HOCl+H⁺=Cl⁻ forming a small amount of hydrochloric and hypochlorous acids as water flows through the channel. Hydrochloric acid is present at about 120 ppm and hypochlorous acid at about 17 ppm. Other reactions occurring in the anodic channel include the formation of small amounts of hydrogen peroxide and ozone (H₂O₂ and O₃). The water from the anode channel is called electrolyzed oxidizing water or acid water. Owing to these chemical species, this solution is both acidic and oxidative. The overall relative oxidative potential is in the range of 1000⁺ to 1200⁺ mV. Bacteria and viruses are readily killed by this solution, but it is safe in regard to humans and animals as accidental ingestion is not harmful.

From the above it is clear that water molecules are split in both channels, but with the chemistry divided by a conductive diaphragm or membrane, the net balance of chemical species is such that alkaline water (pH 11.2 to 11.6) is derived from the cathodic channel, and acid oxidative water (pH 2.8 to 2.3) from the anodic channel. This overall process is driven by the input of electrical energy and hence the term electrolysis.

Electrolyte solutions are typically added to feed water to increase the conductivity of the feed water when producing electrolyzed water in electrolyzing machines. The electrolyzed acidic water produced by this method may be used to clean many soft surfaces and hard surfaces. Electrolyzed acidic water is highly effective for removing dirt and stains, fats from both hard and soft surfaces and demonstrates excellent microbiocidal properties.

It is thought by some scientists that electrolyzed water is restructured such that the cluster size (number of water molecules that are weak-hydrogen-bonded to form molecular aggregates) is smaller than for ordinary water. Smaller cluster size would, predictably, reduce viscosity and increase the solvent qualities of the water. Addition of inorganic ions can alter the solvent capabilities and perhaps slightly restructure water. Inorganic ions are surrounded by a shell of water molecules, the size of which varies with the type of ion. When such modified water is heated and injected into a fabric at high speed by the wand of a commercial carpet cleaning apparatus, it quickly and effective cleanses carpet and fabric fibers. Extraction is further enhanced by formation of micro-droplets of water which are generated by the spray wand aperture. A suitable cleaning apparatus for this purpose is disclosed in U.S. Pat. No. 5,815,869, the entire disclosure of which is included herein by reference.

In certain presently preferred embodiments of the invention, filtered water is used as feed water. However, other types of water can be used for feed water, including tap water, deionized water, and distilled water, or a combination of the aforesaid feed waters.

Acidic electrolyzed water may be effective in reducing the risk of hospital infections by killing disease causing bacteria in a hospital environment. For prevention of hospital infections, thorough cleaning of the hospital environment is an important concern and so far chemical disinfectants have been usually used for this purpose. The microbiocidal effect of electrolyzed oxidizing (EO) water obtained by electrolysis of tap water was examined and determined to be highly effective in killing bacteria and viruses.

A generator of EO water (Toyo Aitex, Inc., Model P-5000) was used for the experiment. The EO water generated from this apparatus was analyzed. The EO water is a mildly but active acidic solution having pH of 2.8 or below, oxidation-reduction potential (ORP) of 1100⁺ mV or more, chloride of about 120 ppm, hydrochloric acid (HCl) of about 120 ppm, hypochlorous acid (HOCl) of about 17 ppm and dissolved oxygen of about 25 mg/liter.

EO was tested in terms of its microbiocidal effect, changed with the passage of time in an open container, changes with the passage of days at room temperature in a transparent, light-resistant closed container, changes with the passage of days at 4° C. in a transparent, light resistant closed container, changes in the microbiocidal effect by heating, and influence of serum addition.

Clinically isolated microbes were cultured. For each organism tested an aliquot of 0.1 ml of bacterial solution was added to 10.0 ml of EO water and 0.1 ml of the mixture was incubated for 48 hours to assess positive or negative bacteria growth. It was determined that the EO water was very effective for killing bacteria at this concentration.

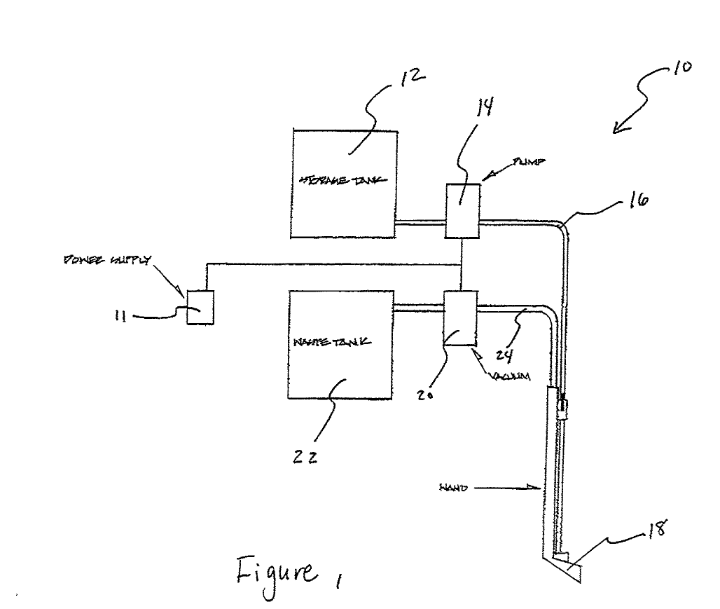

Referring to FIG. 1, a cleaning system for use with electrolyzed oxidizing water is designated 10. The cleaning system includes a storage tank 12 for storing electrolyzed oxidizing water. The electrolyzed oxidizing water is drawn from the storage tank 12 by a pump 14. The electrolyzed oxidizing water travels through a hose 16 and into a wand 18. The water exits the wand 18 under pressure and is sprayed on a surface to be cleaned and disinfected. The surface may be a soft or hard surface. Soft surfaces may include carpets, upholstery, leather, fabrics and the like. Hard surfaces may include tile, plaster, drywall, concrete, linoleum, counter tops, wood, metal and the like.

As the water exits the wand, suction from a vacuum 20 simultaneously draws the water into a second hose 24. The water travels through the second hose 24 to a waste water tank 22. A power supply 11 provides power to the pump 14 and the vacuum 20. The electrolyzed oxidizing water both cleans the surface by removing dirt and oil and also disinfects the surface.

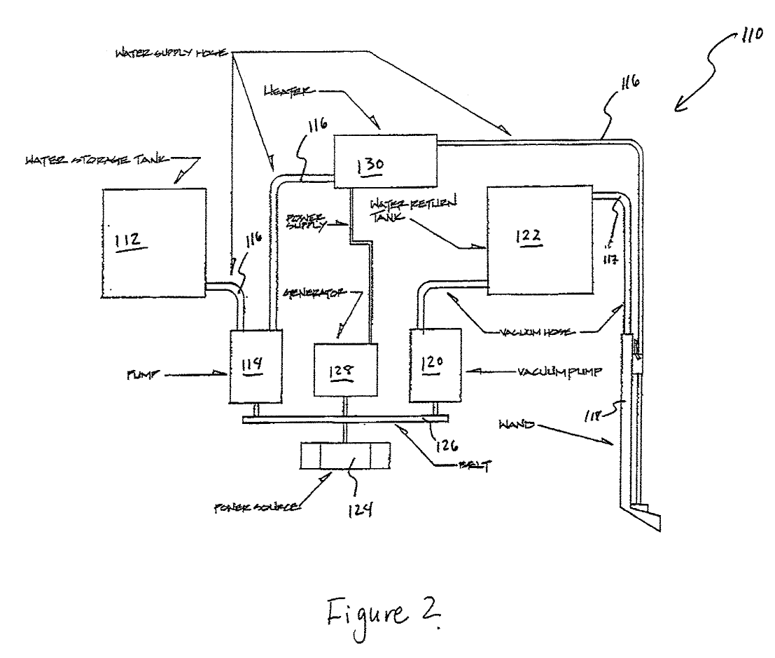

Referring to FIG. 2, an alternate embodiment of a cleaning system is designated 110. The cleaning system 110 includes a storage tank 112 for storing electrolyzed oxidizing water. The electrolyzed oxidizing water is drawn from the storage tank 112 by a pump 114. The electrolyzed oxidizing water travels through a hose 116 to a heater 130 where the water is heated to an optimal temperature for cleaning and disinfecting. The water exits the heater 130 through a hose 116 and travels to a wand 118. The water exits the wand 118 under pressure and is sprayed on a surface to be cleaned and disinfected. The surface may be a soft or hard surface. Soft surfaces may include carpets, upholstery, leather, fabrics and the like. Hard surfaces may include tile, plaster, drywall, concrete, linoleum, counter tops, wood, metal, and the like.

As the water exits the wand, suction is applied by a vacuum 120. The water travels through another hose 116 to the waste water tank 122. The electrolyzed oxidizing water both cleans the surface by removing dirt and oil and also disinfects the surface.

The cleaning system 110 may be mounted to a truck or other vehicle to allow the cleaning system 110 to be taken to many locations. A power source 124 such as the motor from the truck or a gas or electric motor turns a belt 126. The belt 126 powers the vacuum 120, the pump 114, and a generator 128. The generator 128 creates a power supply for running a heater 130. The heater 130 heats the electrolyzed oxidizing water for better cleaning and disinfecting.

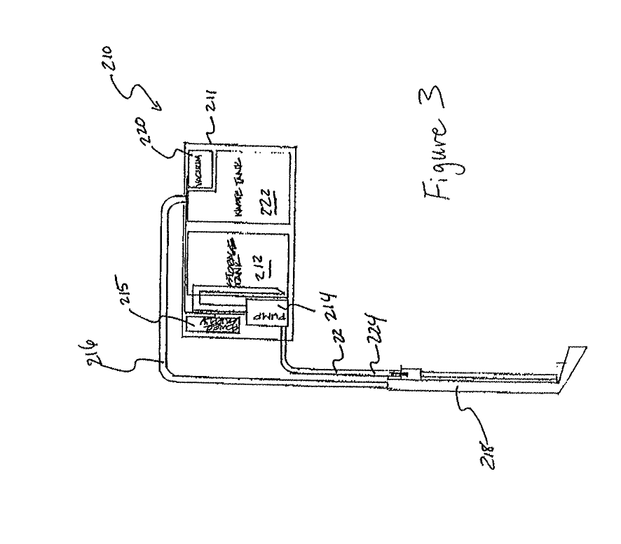

Referring to FIG. 3, a portable or handheld cleaning system is designated 210. The portable cleaning system 210 has a compact body 211 in which the parts of the cleaning system 210 are located. The cleaning system 210 may be mountable on wheels or rollers for ease of mobility. The cleaning system 210 may also be configured with straps allowing a user to carry the cleaning system like a backpack.

A storage tank 212 for storing electrolyzed oxidizing water, a pump 214, a power supply 215, a vacuum, 220, and a waste tank 222 are located within the body 211 of the cleaning system 210. The power supply provides power to the pump 214 and the vacuum 220.

The electrolyzed oxidizing water is drawn from the storage tank 212 by the pump 214. The electrolyzed oxidizing water travels through a hose 216 and into a wand 218. The water exits the wand 218 under pressure and is sprayed on a surface to be cleaned and disinfected. The surface may be a soft or hard surface. Soft surfaces may include carpets, upholstery, leather, fabrics and the like. Hard surfaces may include tile, plaster, drywall, concrete, linoleum, counter tops, wood, metal and the like.

As the water exits the wand 218, suction from the vacuum simultaneously draws the water into a second hose 224. The water travels through the second hose 224 to the waste water 222. The electrolyzed oxidizing water both cleans the surface by removing dirt and oil and also disinfects the surface.

The invention has advantages. By using EO water in the solution, this cleaning system offers cleaning and disinfecting of hard surfaces, including tile, plaster, drywall, concrete, linoleum, counter tops, wood, metal and the like.

While the invention has been shown in only one of its forms, it should be apparent to those skilled in the art that it is not so limited, but is susceptible to various changes without departing from the scope of the invention.

I claim:

1. A cleaning and disinfecting system for cleaning and disinfecting hard surfaces comprising:
a) an electrolyzed oxidizing water storage tank having a volume of electrolyzed oxidizing water contained herein;
b) a regulator located in said electrolyzed oxidizing water outlet line for regulating said amount of said electrolyzed oxidizing water to said electrolyzed oxidizing water outlet line from said electrolyzed oxidizing water storage tank;
c) a cleaning wand communicating with said electrolyzed oxidizing water outlet line for applying said cleaning solution to a hard surface;
d) a waste water tank communicating with said cleaning wand for collecting said cleaning solution from said hard surface; and
e) a vacuum pump which communicates with said waste water tank for collecting said cleaning solution from said hard surface and into said waste water tank.

2. The cleaning system of claim 1, further comprising a water pump communicating with said electrolyzed oxidating water outlet line and located between the electrolyzed oxidizing storage tank and said cleaning wand for pumping said cleaning solution to said cleaning wand.

3. The cleaning system of claim 2, further comprising a water heater located between said water pump and said cleaning wand for heating said cleaning solution before it is applied to said hard surface.

4. The cleaning system of claim 1 wherein the electrolyzed oxidizing water comprises an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of about 17 ppm and dissolved oxygen of about 25.0 mg per liter.

5. The cleaning system of claim 1, wherein the electrolyzed oxidizing water which is an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of 17 ppm and dissolved oxygen of about 25.0 mg per liter is mixed with from between 3 to 5 parts of tap water in the storage tank.

6. The cleaning system of claim 2 wherein the electrolyzed oxidizing water comprises an acidic solution with a pH of about 2.8 or below, an oxidation-reduction potential of 1100⁺ mV or more, chloride of about 120 ppm, hydrochloric acid (HCl) of about 120 ppm, hypochlorous acid (HOCl) of about 17 ppm and dissolved oxygen of about 25.0 mg per liter.

7. The cleaning system of claim 2, wherein the electrolyzed oxidizing water which is an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of 17 ppm and dissolved oxygen of about 25.0 mg per liter is mixed with from between 3 to 5 parts of tap water in the storage tank.

8. The cleaning system of claim 3 wherein the electrolyzed oxidizing water comprises an acidic solution with a pH of about 2.8 or below, an oxidation-reduction potential of 1100⁻ mV or more, chloride of about 120 ppm, hydrochloric acid (HCl) of about 120 ppm, hypochlorous acid (HOCl) of about 17 ppm and dissolved oxygen of about 25.0 mg per liter.

9. The cleaning system of claim 3, wherein the electrolyzed oxidizing water which is an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of 17 ppm and dissolved oxygen of about 25.0 mg per liter is mixed with from between 3 to 5 parts of tap water in the storage tank.

10. A cleaning system for cleaning hard surfaces comprising:
(a) an electrolyzed oxidizing water storage tank having a volume of electrolyzed oxidizing water contained therein;
(b) a regulator located in said electrolyzed oxidizing water outlet line for regulating said amount of said electrolyzed oxidizing water to said electrolyzed oxidizing water outlet line from said electrolyzed oxidizing water storage tank;
c) a cleaning wand communicating with said electrolyzed oxidizing water outlet line for applying said cleaning solution to a hard surface;
d) a water pump communicating with said electrolyzed oxidizing water outlet line and located between the electrolyzed oxidizing storage tank and said cleaning wand for pumping said cleaning solution from said electrolyzed oxidizing water outlet line to said cleaning wand,
e) a water heater located in series between said water pump and said cleaning wand for heating said cleaning solution before it is applied to said hard surface;
f) a waste water tank having a vacuum hose which communicates with said cleaning wand for collecting said cleaning solution from said hard surface; and
g) a vacuum pump which communicates with said waste water tank for collecting said cleaning solution from said hard surface through said cleaning wand and into said waste water tank.

11. The cleaning system of claim 10 wherein the electrolyzed oxidizing water comprises an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of about 17 ppm and dissolved oxygen of 25.0 mg per liter.

12. The cleaning system of claim 10, wherein the electrolyzed oxidizing water which is an acidic solution with a pH of 2.8 or below, an oxidation-reduction potential of 1100⁺ mV or more, chloride of about 120 ppm, hydrochloric acid (HCl) of about 120 ppm, hypochlorous acid (HOCl) of 17 ppm and dissolved oxygen of about 25.0 mg per liter is mixed with from between 3 to 5 parts of tap water in the storage tank.
